(19) United States
(12) Patent Application Publication
(10) Pub. No.: US 2007/0251331 A1
(43) Pub. Date: Nov. 1, 2007

(54) Method for Monitoring Duct Ventilation

(76) Inventor: Pierre Charlat, Lans En Vercors (FR)

Correspondence Address: AIR LIQUIDE;Intellectual Property, 2700 POST OAK BOULEVARD, SUITE 1800, HOUSTON, TX, 77056, US

(21) Appl. No.: 11/569,792

(22) PCT Filed: May 17, 2005
(86) PCT No.: PCT/FR05/50333

§ 371 Date: Jul. 5, 2007

(30) Foreign Application Priority Data
Jun. 16, 2004 (FR) 0406522

(51) Int. Cl. G01F 1/00

(52) U.S. Cl. 73/861.77

(57) ABSTRACT

A method for monitoring ventilation in a duct (3) by inserting therein a secondary fan (5) have a low self-contained rotation speed, which method comprises a step of continually measuring an image value (vᵢ) of the current flowing through the motor in order to compare same with a predetermined value and generate a correction signal. The method is particularly useful for ventilating a chamber (2) containing a PEM fuel cell (1).

The present invention relates to a method for monitoring ventilation in a duct, typically one for evacuating gaseous components from an enclosure, comprising means of circulating gas in the duct.

In installations necessitating ventilation for safety reasons, it is appropriate to have means of detecting a ventilation failure due, for example, to opposing winds, or of detecting a non-functioning of the extractor fan.

In the known systems, this monitoring is carried out by measurements of the gas flow in the duct, using hot wire anemometers or differential pressure sensors in arrangements which are usually expensive and difficult to maintain and not generally suitable for monitoring low flow rates.

The purpose of the present invention is to propose a method that is simple, effective, very inexpensive and which is also suitable for monitoring very low ventilation flow rates, in particular for installations using fuel cells, for evacuating the impoverished output air flow and possible hydrogen leakages.

In order to do this, in the method according to the invention, a secondary direct current fan is inserted in the duct, a minimum voltage is applied to the motor of the fan sufficient to ensure a continuous rotation, an image value of the current passing through the motor is measured continuously and it is compared with a pre-established value in order to generate a correction signal.

According to the particular features of the invention:
the image value of the current is an average value of this current and/or its frequency;
the correction signal is an alarm signal;
the method is applied to the ventilation of an enclosure containing a source of emission of gaseous components whose concentration must be monitored, for example a fuel cell having a proton exchanger membrane (PEM).

Other features and advantages of the invention will emerge from the following description of embodiments, given by way of illustration but in no way limiting and given with reference to the appended drawings in which:

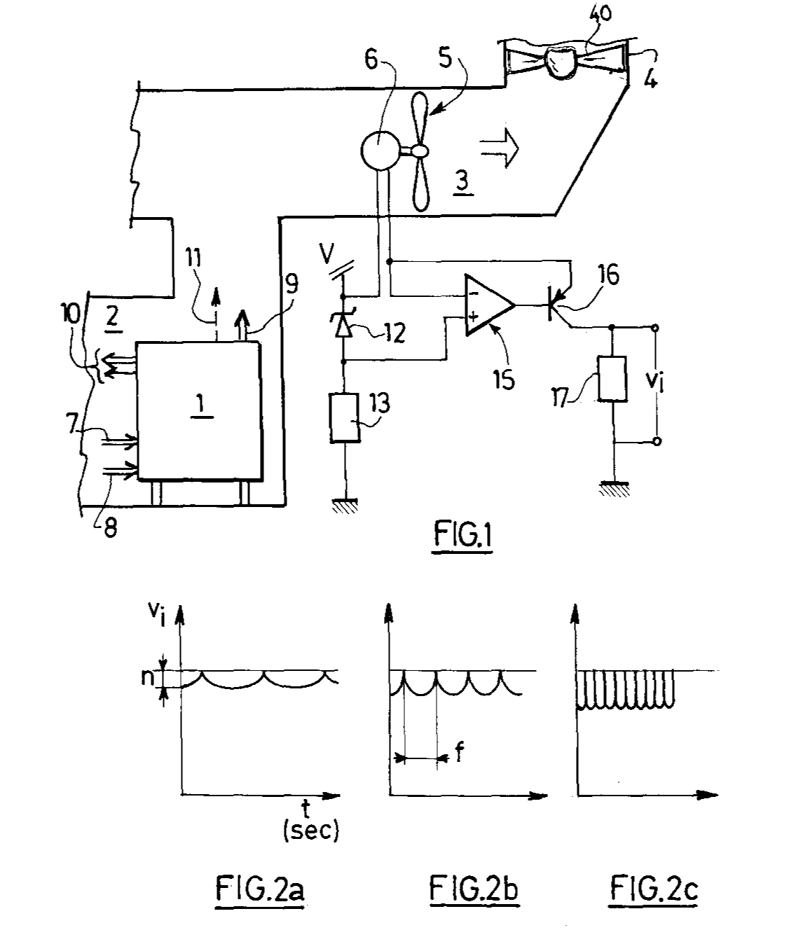

FIG. 1 is a block diagram of an installation for the implementation of the method according to the invention; and

FIGS. 2a to 2c are voltage/time graphs showing the variation over time of the power supply of the motor in different conditions.

FIG. 1 shows, by way of example, a fuel cell 1 placed in an enclosure 2, for example a room, connected via an evacuation duct 3 to an evacuation chimney 4 comprising a high flow rate extractor fan 40.

The fuel cell 1 comprises an inlet 7 for oxidant, typically air, a hydrogen inlet 8, an outlet 9 for impoverished air and electrical energy outputs 10. The possible hydrogen leakages are represented by the arrow drawn in dotted line 11.

According to one aspect of the invention, in the duct 3 is disposed a secondary fan/anemometer 5 driven at a very low speed of rotation by a brushless electric motor 6; the power supply voltage of the motor 6 just makes it possible to maintain a slow rotation of the fan 5 in the absence of forced airflow in the duct 3. In the natural extraction or forced by the extractor 4 configuration, the secondary fan 5 participates in no more than 5% of the ventilation flow and is not likely by itself alone to create an extraction flow, not even a low one.

As shown diagrammatically in FIG. 1, the monitoring circuit of the fan 5 typically comprises, inserted in the power supply circuit of the motor 6, a reference voltage Zener diode 12 with its bias resistor 13, on the one hand, and an operational amplifier 15 coupled with a bipolar transistor 16 whose collector makes it possible to supply, across the terminals of a measuring resistor 17, a measurement voltage vᵢ which is an image of the flow circulating in the duct 3.

In fact, as shown in FIGS. 2a to 2c, the trend (amplitude n with respect to a reference value vₙ and frequency f) gives an indication of the flow circulating in the duct 3.

FIG. 2a, with a signal of low amplitude and a long period of rotation of the motor, corresponds to a zero gas flow rate. FIG. 2b, with a marked amplitude and a low frequency f, corresponds to a moderate flow rate. FIG. 2c, with a high amplitude and a high frequency, corresponds to a high flow rate. In the case of a failure of the motor VI, the signal corresponds simply to a straight line with neither amplitude nor frequency.

As will be understood from the above, reading the value of the current which flows through the motor 5 as a function of time gives an image of the flow passing through said fan 5 in its normal direction of operation (a low reverse flow stopping the system immediately) and therefore of the flow of the evacuated gasses in the duct 3 and in the chimney 4.

The measured value exhibits peaks of which the maximum is at a fixed value and depends very little on the speed of rotation. On the other hand, the average value of the current reduces as the flow increases, as does the frequency of the peaks. By measuring the average value (low-pass filtering) or by a conventional measuring of frequency, immediate access to information on the flow of gas circulating in the duct 3 is gained. This measurement can be used for adapting the system parameters and for comparing it, in a conventional manner, with a threshold value in order to carry out corrective or safety measures (stopping the installation for example). It is also possible to check, whatever the flow may be, that the monitoring system is operating correctly due to the presence of the current peaks. It is also possible, in order to increase the reliability level, to carry out a comparison in order to check the consistency between the average value and the frequency of the peaks and to take corrective measures in the event of too large a deviation. Finally, it is possible to check that the maximums are always at the correct value and to initiate safety measures in the event of a deviation that is too large.

Although the invention has been described with regard to a particular embodiment, it is not thereby limited and modifications and variants which will be apparent to those skilled in the art can be applied to within the scope of the following claims.

1-7. (canceled)

8. A method for monitoring ventilation in a duct, wherein a secondary fan having a brushless direct current motor is inserted in the duct, a minimum voltage is applied to the motor sufficient to ensure a continuous rotation, an image value of the current passing through the motor is measured continuously and it is compared with a pre-established value in order to generate a correction signal.

9. The method of claim 8, wherein the image value is an average value of the current.

10. The method of claim 8, wherein the image value is the frequency of the peaks of the current.

11. The method of claim 8, wherein the correction signal is an alarm signal.

12. The method of claim 8, wherein the correction signal is a signal to vary the voltage applied to the motor.

13. The method of claim 8, for the ventilation of an enclosure containing a source of emission of gaseous components whose concentration must be monitored.

14. The method of claim 13, wherein the source of emission is a fuel cell.
